(19) United States
(12) Patent Application Publication
(10) Pub. No.: US 2024/0201393 A1
(43) Pub. Date: Jun. 20, 2024

(54) SELF-PROPELLED CONSTRUCTION MACHINE AND METHOD FOR WORKING THE GROUND OR ERECTING A STRUCTURE ON THE GROUND

(71) Applicant: Wirtgen GmbH, Windhagen (DE)

(72) Inventors: Martin Buschmann, Neustadt (DE); Henning Delius, Edenkoben (DE)

(21) Appl. No.: 18/541,117

(22) Filed: Dec. 15, 2023

(30) Foreign Application Priority Data
Dec. 19, 2022 (DE) 10 2022 133 913.0

(51) Int. Cl. G01S 19/13

(52) U.S. Cl. CPC G01S 19/13; E01C 23/088

(57) ABSTRACT

A self-propelled construction machine for working ground or erecting a structure thereon in a preceding work process, which is followed by another work process with another construction machine, comprises a mobile radio communications device, a GNSS receiver, a GNSS evaluation device or mobile radio evaluation device, and a GNSS evaluation variable acquisition device or mobile radio evaluation variable acquisition device. The GNSS evaluation device or mobile radio evaluation device is configured wherein, during advance of the machine, evaluation variables evaluating the quality of the GNSS signals or the mobile radio signal are determined at respective locations in the terrain, and the GNSS evaluation variable acquisition device or the mobile radio evaluation parameter acquisition device is configured wherein the position data determined by the GNSS receiver at the respective locations is used to generate a spatial (geo-referenced) telemetry data set describing the quality of the signals at the respective locations.

### CROSS-REFERENCES TO RELATED APPLICATIONS

This application claims the benefit of German Patent Application No. DE 10 2022 133 913.0, filed Dec. 19, 2022, and which is hereby incorporated by reference.

### FIELD OF THE INVENTION

The present disclosure relates generally to a self-propelled construction machine for working the ground or erecting a structure on the ground in a preceding work process, which is followed by another work process with another construction machine. More particularly, the present disclosure in various embodiments relates to a system comprising a self-propelled construction machine for working the ground or erecting a structure on the ground in a preceding work process followed by another work process with another construction machine, and a cloud memory and a method for working the ground or erecting a structure on the ground with a self-propelled construction machine in a preceding work process followed by another work process with another construction machine.

### BACKGROUND

Self-propelled construction machines are characterized as having a working device arranged on a machine frame for working the ground, e.g., for milling the ground, or erecting a structure, e.g., a roadway, on the ground. As used herein, the ground may be understood to mean the subsurface, which can also be a (damaged) road to be worked. The self-propelled construction machine can be a road milling machine, a recycler, a soil stabiliser, a bulldozer, a roller, a grader, a road paver, a slipform paver, or a feeder. In the case of road milling machines, for example, the working device comprises a milling drum fitted with milling tools, which can be used to remove material in a specified working width. In the case of road pavers, for example, the working device comprises a screed with which material for a roadway can be installed.

In the case of self-propelled construction machines, a largely automatic control of the construction machine is sought, without significant interventions by the vehicle driver.

A known method for controlling self-propelled construction machines presupposes the use of a guide wire, with which a trajectory is specified. Self-propelled construction machines can, however, also be controlled using a total station for positioning and/or a global navigation satellite system (GNSS), which comprises a plurality of satellites.

The control of construction machines with a global navigation satellite system (GNSS) has proven successful in practice. However, this control of construction machines requires the reception of the signals from the GNSS. In practice, however, the reception of the satellite signals can be disrupted by shadows caused by trees or building coverage, for example, with the result that the GNSS cannot determine the position of the construction machine at a location in the terrain, or cannot do so with sufficient accuracy.

However, for precise positioning, not only is the signal strength of the satellite signals of decisive importance, but also further factors. Positioning using a GNSS is based upon the determination of the distances to the satellites by signal runtime measurement. The accuracy of the positioning is thus dependent upon the position of the available satellites with respect to one another (satellite constellation) and upon the accuracy of the time measurement (runtime). All factors determining the accuracy of the positioning therefore have an influence on the quality of the GNSS signals. Below, the quality of the GNSS signals is understood to mean a quality criterion for the accuracy of the positioning. Precise positioning therefore requires high quality GNSS signals. GNSS signals are also understood to mean all correction signals that enable an improvement in the accuracy of the positioning.

A road milling machine which has a position determining system is known from DE 197 56 676 C1. The construction machine has a rover unit for receiving satellite signals from a global navigation satellite system (GNSS) and correction signals from a reference station, wherein the rover unit is configured to determine position data describing the position of a reference point on the construction machine in a coordinate system independent of the construction machine based upon the satellite signals and the correction signals.

In order to transmit digital signals (data) between digital terminals over long transmission paths, known construction machines generally have a mobile radio communications device. In practice, it has been found that the reception of the mobile radio signals on the construction site can also be disrupted. In this respect, the quality of the mobile radio signal is also of decisive importance for automated control of the construction machine. The mobile radio communications device also allows a reception of correction signals of a DGNSS (differential GNSS) if the correction signals are transmitted via a GSM (global system for mobile communications).

Various construction machines are used on construction sites, which form a system of construction machines and whose operation must be considered as a whole. The known road milling machines can be operated, for example, for removing damaged road layers in a preceding work process. In a subsequent work process that does not have to take place on the same day, a bonded layer, e.g., asphalt, can then be installed using a road paver.

An automatic control of the construction machine used in the subsequent work process using a GNSS and the use of a mobile radio network requires a high quality of the GNSS signals or of the mobile radio signal.

If the quality of the GNSS signals or mobile radio signals is not sufficient, it is necessary to take appropriate technical precautions for the subsequent work process. For example, the known repeaters for amplifying the mobile radio signals of a GSM can be set up on the construction site. However, since no repeaters are available for GNSS signals, a change must be made to an alternative system. In this case, a terrestrial positioning system can be used, e.g., a total station.

### BRIEF SUMMARY

An object of a construction machine or method in accordance with the present disclosure may be to provide technical means with which the planning of the construction project can be simplified, the operational efficiency of the construction machines working as a whole can be improved, downtimes can be avoided, and costs can be saved. In particular, a construction machine, and in particular a road milling machine, recycler, soil stabiliser, bulldozer, roller, grader, road paver, slipform paver, or feeder, may be provided which allows the quality of the GNSS signals or mobile radio signals on the construction site to be determined for a subsequent work process with another construction machine.

Various embodiments as described herein can comprise one or more of the features or feature combinations mentioned below. A feature denoted by an indefinite article can also be present multiple times if the indefinite article is not to be understood with an explicit indication of only one-time use. A denotation of features by a numeral, e.g., “first and second,” does not preclude that these features can be present more times than the number indicated by the numeral. In the description of all embodiments, the expression, “can,” is also to be understood as “preferably” or “expediently”.

A self-propelled construction machine as disclosed herein, and in particular a road milling machine, recycler, soil stabiliser, bulldozer, roller, grader, road paver, slipform paver, or feeder, has a machine frame supported by running gears, on which a working device is provided, which can, for example, be a milling drum or milling/mixing rotor, and at least one drive device for driving the running gears, so that the construction machine can perform translational and/or rotational movements in the terrain and work the ground or erect a structure, e.g., a roadway, on the ground. If the working device requires a drive, e.g., a milling drum, the drive device can also drive the working device. Furthermore, the construction machine comprises a mobile radio communications device which has a mobile radio antenna for transmitting and receiving a mobile radio signal and a computing unit for processing a mobile radio signal. A mobile radio communications device is understood to mean all devices with which a mobile radio connection can be established in order to transmit signals (data). Furthermore, the construction machine has a GNSS receiver which comprises an antenna arranged at a reference point of the construction machine for receiving GNSS signals of a plurality of satellites of a global navigation satellite system and a computing unit for processing GNSS signals and outputting position data describing the position of the reference point. In this context, GNSS signals are also understood to mean correction signals (correction data) with which errors in the positioning can be corrected in real time. The positioning can occur in a two- or three-dimensional coordinate system which can be a coordinate system independent of the construction machine.

An embodiment of a construction machine as disclosed herein provides a GNSS evaluation device which is set up in such a way that, during the advance of the construction machine at a plurality of locations in the terrain, at least one GNSS evaluation variable evaluating the quality of the GNSS signals at the particular location is determined, i.e., a variable, e.g., the signal strength, which is characteristic of the quality of the GNSS signals. The GNSS evaluation variable can also be a variable describing the quality of correction signals or correction data.

Furthermore, the construction machine as disclosed herein may comprise a GNSS evaluation variable acquisition device which is set up in such a way that the position data determined by the GNSS receiver at the particular locations in the terrain is used to generate a spatial (geo-referenced) GNSS telemetry data set describing the quality of the signals at the particular locations. The GNSS evaluation variable acquisition device can generate the GNSS telemetry data set in that the GNSS signals received by the GNSS receiver and the GNSS evaluation variables resulting therefrom are detected, and spatial information (geo-reference) is assigned to the GNSS evaluation variables based on the GNSS signals. The GNSS telemetry data set can also contain data which describe the time (date and time) at which the quality of the GNSS signals is evaluated (time stamp), so that a possible dependence of the accuracy of the positioning upon time can also be taken into account in the further evaluation. The GNSS telemetry data set can also contain data which describe whether correction data are received from geostationary satellites or ground stations. The GNSS evaluation variables contained in the GNSS telemetry data set can also describe the quality of the correction data.

The GNSS evaluation device and/or the GNSS evaluation variable acquisition device can have a computing unit which can be a component of a central control and computing unit of the construction machine. The computing unit of the GNSS evaluation device and/or GNSS evaluation variable acquisition device can also be a component of the computing unit of the GNSS receiver or of another assembly of the construction machine.

The GNSS evaluation variable acquisition device interacts with the mobile radio communications device in such a way that the spatial GNSS telemetry data set can be sent to a cloud memory of an Internet service provider.

The GNSS telemetry data set generated by the GNSS evaluation variable acquisition device can comprise non-processed raw data which must still be processed for further use with a suitable data processing device. However, the computing unit of the GNSS evaluation variable acquisition device can also be set up to process the data on the construction machine.

The planning of the construction project can take place based on the GNSS telemetry data set provided in the cloud memory, which can be downloaded from the cloud memory and evaluated. Consequently, the spatial GNSS telemetry data set is available at any time for the subsequent work process, e.g., in a planning office. Since the GNSS telemetry data set is already available before the beginning of the following work process, the precautions required for the subsequent work process can be made in good time. The GNSS telemetry data set can also be sent to the following construction machine, i.e., uploaded to the cloud memory and downloaded from the cloud memory by the following construction machine, in order to perform interventions in the machine control as a function of the quality of the GNSS signals. The decisive advantage lies in the fact that the construction machine according to the invention not only functions to work the ground or erect a structure on the ground, but also to acquire the GNSS telemetry data set.

A construction machine as disclosed herein can be part of a system for working the ground, which comprises the construction machine, a cloud memory of an Internet service provider, which can also be the manufacturer of the construction machine, and a data processing device with a mobile radio communications device for establishing a mobile radio connection. The GNSS telemetry data set can be read out of the cloud memory using the data processing device, and the data of the GNSS telemetry data set can be processed with the data processing device. The data of the GNSS telemetry data set can be visualised on a screen of the data processing device. The data processing device can, for example, be a computer, a laptop, or a mobile radio device. Corresponding software (app) can be downloaded to these devices.

The GNSS evaluation variable acquisition device can be set up in such a way that, in order to generate the spatial GNSS telemetry data set during the advance of the construction machine, the at least one GNSS evaluation variable evaluating the quality of the GNSS signals at the particular location is continuously acquired after traveling a predetermined distance, or after the expiration of a predetermined time interval. In this case, waypoints which lie on the left and on the right of the trajectory at a specific distance in the working direction can be assigned to the same evaluation variables. Consequently, a path with a predetermined width, e.g., the path to be worked by the construction machine, the width of which (lane width) is known, can be divided into individual regions, each of which is assigned a GNSS evaluation variable. The data can be stored in a memory in the form of a table. The individual regions then have a certain width, which can correspond to the track width, and a predefined length which results from the predetermined distance or the prespecified time interval. Instead of signal detection only at certain locations, the signals can also be continuously detected during the advance of the construction machine.

The GNSS evaluation variable acquisition device can furthermore be set up in such a way that colours are assigned to the values of the at least one GNSS evaluation variable evaluating the quality of the GNSS signals at the particular location (heat mapping), in order to represent the values of the at least one GNSS evaluation variable at the particular locations in a graphical representation of the area to be processed by the construction machine as colour-coded regions (heat mapping). The data of the GNSS telemetry data set can be combined in an image file in the known formats, which is uploaded to the cloud memory. Further processing of the data is then no longer required. However, the image data for visualisation can also first be generated with the external data processing device.

The acquisition of the data by the operator (planner) can be facilitated by the fact that the GNSS evaluation variable acquisition device is set up in such a way that, in order to generate the spatial GNSS telemetry data set, the at least one GNSS evaluation variable evaluating the quality of the GNSS signals at the particular location is evaluated taking into account at least one evaluation criterion, wherein the GNSS evaluation variable acquisition device is configured to make the decision whether the at least one GNSS evaluation variable satisfies the at least one evaluation criterion at the particular location, or whether the at least one GNSS evaluation variable does not satisfy the at least one evaluation criterion. A suitable criterion can, for example, be that of exceeding or falling below a limit value. However, the evaluation variables can also be evaluated using more complex signal analysis.

The GNSS evaluation device can be set up in such a way that a value correlating with the signal strength of the GNSS signals of the satellites of a global navigation satellite system and/or a value correlating with the satellite geometry is determined as a GNSS evaluation variable evaluating the quality of the GNSS signals. Various evaluation variables are known for evaluating the signal quality. In addition to the signal strength of the individual satellites, an evaluation variable can, for example, be a DOP (dilution of precision) value (H(horizontal)DOP or V(vertical)DOP) or GDOP (geometric dilution of precision) value, which is a measure of the scattering width of the measured values dependent upon the satellite geometry in a GNSS.

In various embodiments, evaluation of the quality of the mobile radio signal is conducted by the construction machine. This aspect may be fundamentally independent from evaluation of the GNSS signal. However, it is advantageous if the construction machine allows the evaluation of both signals.

An embodiment of a construction machine as disclosed herein comprises a mobile radio evaluation device which is set up in such a way that, during the advance of the construction machine at a plurality of locations in the terrain, at least one mobile radio evaluation variable evaluating the quality of the mobile radio signal at the particular location is determined, and a mobile radio evaluation variable acquisition device which is set up in such a way that, with the position data determined by the GNSS receiver at the particular locations in the terrain, a spatial mobile radio telemetry data set describing the quality of the mobile radio signal at the corresponding locations is generated.

The mobile radio telemetry data set can also contain data which describe the time (date or time) at which the quality of the mobile radio signals is evaluated (time stamp), so that, during the further evaluation, a possible dependence of the signal quality upon time can also be taken into account.

The mobile radio evaluation variable acquisition device interacts with the mobile radio communications device in such a way that the spatial mobile radio telemetry data set is sent to a cloud memory of an Internet service provider.

The mobile radio evaluation variable acquisition device can be set up in such a way that, to generate the spatial mobile radio telemetry data set during the advance of the construction machine, the at least one mobile radio evaluation variable determined by the mobile radio evaluation device is acquired in each case after a traveling a predetermined distance, or after the expiration of a predetermined time interval.

The mobile radio evaluation variable acquisition device can furthermore be set up in such a way that colours are assigned to the values of the at least one mobile radio evaluation variable evaluating the quality of the mobile radio signal at the respective location, in order to display the values of the at least one mobile radio evaluation variable at the particular locations in a graphical representation of the area to be processed by the construction machine as colour-coded regions.

In addition, the mobile radio evaluation parameter acquisition device can be set up in such a way that, in order to generate the spatial mobile radio telemetry data set, the at least one mobile radio evaluation variable evaluating the quality of the mobile radio signal at the respective location is evaluated taking into account at least one evaluation criterion, wherein the mobile radio evaluation variable acquisition device is set up to make the decision whether the at least one mobile radio evaluation variable satisfies the at least one evaluation criterion at the respective location, or whether the at least one evaluation parameter does not satisfy the at least one evaluation criterion.

A value correlating with the signal strength of the mobile radio signal, and/or a value correlating with the runtime of the mobile radio signal, and/or a value correlating with the upload rate and/or download rate of the mobile radio signal can be determined as a mobile radio evaluation variable evaluating the quality of the mobile radio signal. A value describing the signal strength is, for example, the known RSSI (received signal strength) value. The mobile radio evaluation variable can also describe the mobile radio standard, e.g., LTE, 3G, 5G, etc.

The GNSS evaluation variable and the mobile radio evaluation variable can also describe the state that GNSS signals or mobile radio signals are not received at all. If the GNSS evaluation variable or the mobile radio evaluation variable is the signal strength, this state can be inferred if the signal strength is equal to 0. Consequently, the particular telemetry data set also describes this state.

In the case of mobile radio reception disrupted on the entire construction site, the GNSS or mobile radio telemetry data set cannot be uploaded to a cloud memory. However, if a telemetry data set is not available in the cloud, this total failure can at least be inferred. Otherwise, the respective telemetry data record can be uploaded to the cloud storage at a time when mobile radio reception is not disrupted.

In the event of disrupted reception of the GNSS signals during the advance of the construction machine, a GNSS telemetry data set or mobile radio telemetry data set cannot be generated which contains spatial data for the relevant route section, since geo-referencing is not possible in this route section. However, the telemetry data set or mobile radio telemetry data set contains information at the waypoints at which GNSS signals are no longer received during the advance of the construction machine, i.e., the signal strength is 0, and at the waypoints at which GNSS signals are received again, i.e., the signal strength is again greater than 0. If, for example, mobile radio signals are received, but GNSS signals are not received, the waypoints at which the mobile radio signals are evaluated can be determined based on additional information (data) and/or additional systems, so that geo-referencing can still be carried out. For example, the position of the construction machine can be approximated taking into account the known positions at which the signal reception fails or restarts. The GNSS evaluation variable acquisition device can, for example, also interact with an inertial navigation system (INS), which has an inertial measurement unit (IMU) with several acceleration and rotation rate sensors, in order to continuously determine the spatial movement of the construction machine and, therefrom, its corresponding position.

### BRIEF DESCRIPTION OF THE SEVERAL VIEWS OF THE DRAWINGS

FIG. 1 shows a side view of an exemplary embodiment of a construction machine according to the invention.

FIG. 2 shows a highly simplified schematic representation of the construction machine.

FIG. 3A shows the construction machine while working the ground in a first working step.

FIG. 3B shows the construction machine while working the ground in a second working step.

FIG. 4 shows a table with the data of the spatial GNSS telemetry data set.

FIG. 5 shows the visualization of the GNSS telemetry data set on the screen of a data processing device.

### DETAILED DESCRIPTION

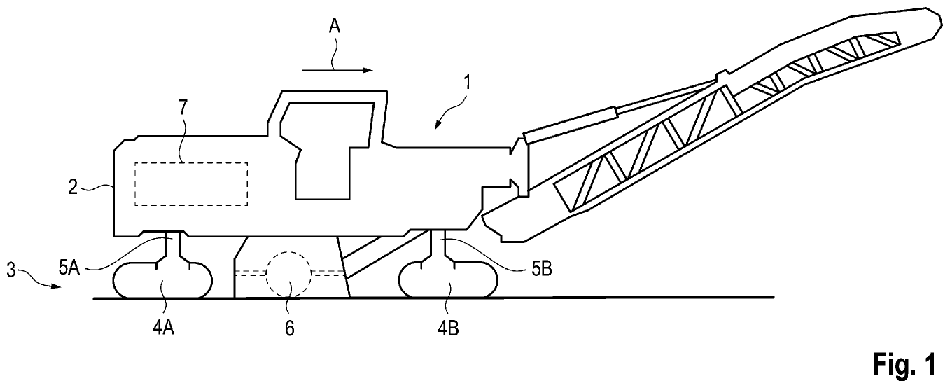

FIG. 1 shows a side view of a road milling machine as an example of a self-propelled construction machine 1.

The construction machine 1 has a machine frame 2 which is supported by a chassis 3. The chassis 3 has two rear and two front steerable running gears 4A, 4B which are fastened to rear and front lifting columns 5A, 5B so that the construction machine 1 can execute translational and/or rotational movements on the terrain. The construction machine 1 has a working device 6 for working the ground. In the present exemplary embodiment, the working device is a milling drum equipped with milling tools. A drive device 7, shown only in outline in FIG. 1, is provided for driving the running gears 4A, 4B and the working unit 6. The working direction (direction of travel) of the construction machine 1 is indicated by an arrow A.

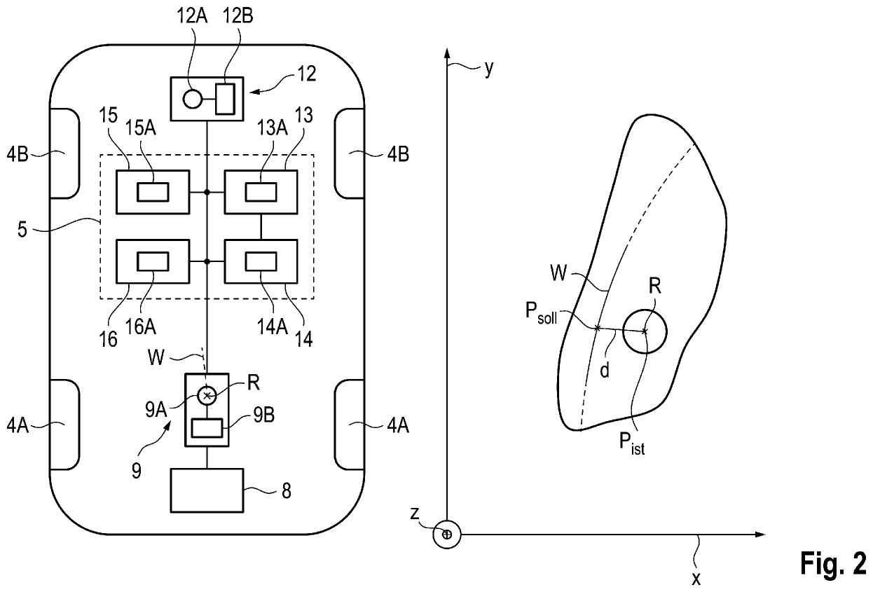

FIG. 2 is a highly simplified schematic representation of the construction machine 1 of FIG. 1. Corresponding parts are provided with the same reference signs.

In the present embodiment, the construction machine 1 has an automatic control using a global navigation satellite system (GNSS). Such a control belongs to the prior art. The control device 8 for controlling the drive device 7 of the construction machine 1 controls the running gears 4A, 4B in such a way that a reference point R of the construction machine moves along a specific path W, i.e., along the path or at a distance from the path (equidistant). The reference point R can be any point on the construction machine. The control device 8 is set up so that the steerable running gears 4A, 4B are controlled in such a way that the distance d between the desired position Pₛₒₗₗ described by a target distance and the actual position Pᵢₛₜ of the reference point R is minimal. FIG. 2 shows an enlarged view of a deviation d of the actual position Pᵢₛₜ from the target position Pₛₒₗₗ on the right-hand side of the image. The reference point R of the construction machine 1 on the left-hand side of the image lies on the target distance W. The target distance W can describe the course of a road, for example.

The actual position Pᵢₛₜ of the reference point R is determined using the GNSS with a GNSS receiver 9 which has an antenna 9A arranged at the reference point R for receiving GNSS signals from a plurality of satellites 10 of a global navigation satellite system (GNSS) and a computing unit 9B for processing GNSS signals and outputting position data describing the position of the reference point in a coordinate system (x, y, z) independent of the construction machine. Such a GNSS receiver belongs to the prior art. The GNSS signals received by the GNSS receiver can also comprise correction signals for increasing the accuracy of the positioning (DGNSS).

In order to establish a mobile radio connection to a mobile radio unit 11 of a mobile radio provider, the construction machine 1 has a mobile radio communications device 12 which has a mobile communications antenna 12A for transmitting and receiving a mobile radio signal and a computing unit 12B for processing a mobile radio signal. Such a mobile radio communications device also belongs to the prior art. Correction signals for increasing the accuracy of positioning can also be received by the mobile radio communications device when correction signals are available via a GSM, and these correction signals are to be used.

Furthermore, the construction machine 1 comprises a GNSS evaluation device 13 and a GNSS evaluation variable acquisition device 14, and/or a mobile radio evaluation device 15 and a mobile radio evaluation variable acquisition device 16, which can each have a separate computing unit 13A, 14A, 15A, 16A for processing the data. The GNSS evaluation device and GNSS evaluation variable acquisition device, or the mobile radio evaluation device and the mobile radio evaluation variable acquisition device can also have a common computing unit. The computing unit(s) can also be a component of a central computing and control unit(s) for controlling the operation of the construction machine. Where steps and/or functions are described herein as being performed by a respective device and/or computing unit, in various embodiments and in appropriate contexts it may be understood that some or all of the steps and/or functions may be performed by one central device and/or computing unit, or one or more such devices and/or computing units. Otherwise stated, where one or more devices and/or computing units are described in association with a step and/or function, it may be understood that respective devices and/or computing units may be configured to perform such a step and/or function, that individual devices and/or computing units from a plurality of such devices and/or computing units may perform more than one of the respective steps and/or functions, that a single device and/or computing unit may perform all of the respective steps and/or functions, and the like. Hardware components associated with the devices, computing units, etc., can comprise, for example, general processors, digital signal processors (DSP's) for continuous processing of digital signals, microprocessors, application-specific integrated circuits (ASIC's), integrated circuits (FPGA's) comprising logic elements, or other integrated circuits (IC's), in order to carry out the computing operations described below. A data processing program (software) can run on the hardware components in order to carry out the individual method steps.

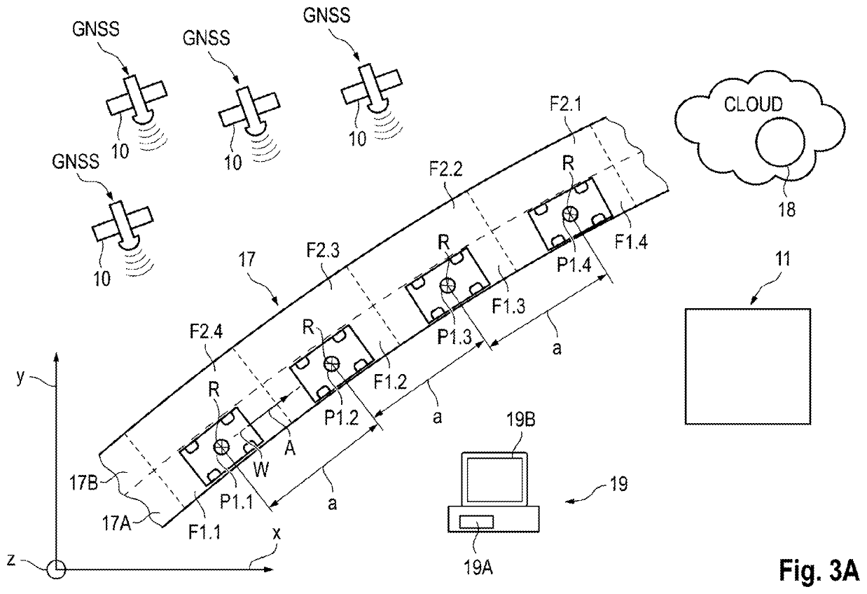

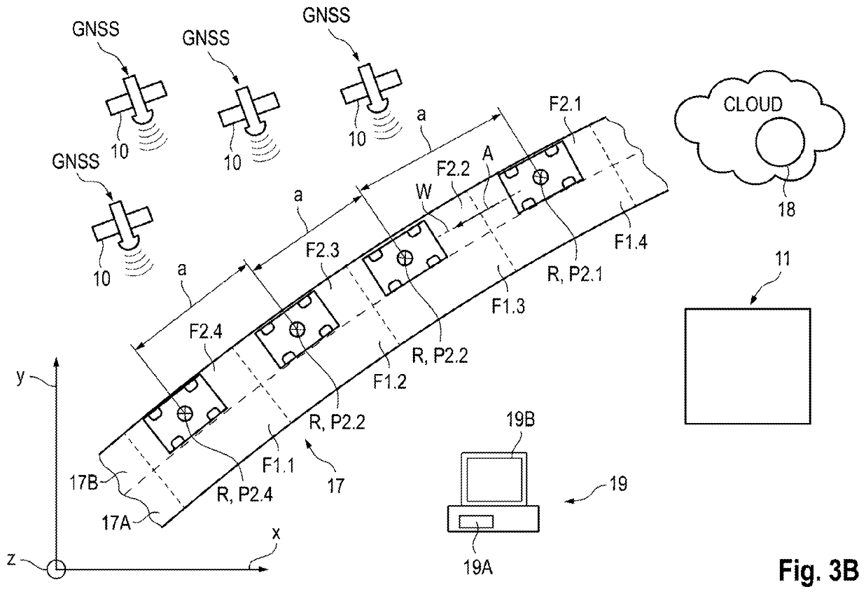

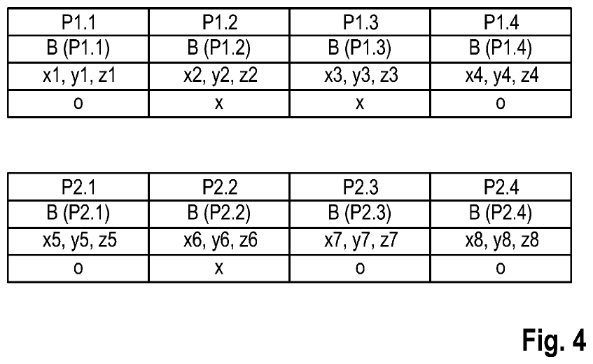

The function of the GNSS evaluation device 13 and the GNSS evaluation variable acquisition device 14 is described below with reference to FIGS. 3A and 3B and FIG. 4.

FIGS. 3A and 3B show a road 17 to be worked by the construction machine 1, which road has a left and right lane 17A, 17B. In the present exemplary embodiment, the damaged road 17 is to first be milled with the construction machine 1. Asphalt is to be laid at a later time using a road paver.

In a first operation, the construction machine 1 processes the right lane 17A (FIG. 3A), and in a second operation, the left lane 17B (FIG. 3B). In FIGS. 3A and 3B, the working direction of the construction machine 1 is denoted by A, and the reference point of the construction machine, on which the antenna 9A of the GNSS receiver 9 is located, by R. During the advance of the construction machine 1 in working direction A, the GNSS receiver 9 generates the position data on the right half of the road 17A at least at the waypoints P1.1, P1.2, P1.3, P1.4, and on the left half of the road 17B at the waypoints P2.1, P2.2, P2.3, P2.4.

The GNSS evaluation device 13 is set up in such a way that, during the advance of the construction machine 1, at least one GNSS evaluation variable B evaluating the quality of the GNSS signals at the particular location is determined at a plurality of locations in the terrain. In the present exemplary embodiment, the GNSS signals are evaluated at waypoints P1.1, P1.2, P1.3, P1.4 on the right half of the road 17A and at waypoints P2.1, P2.2, P2.3, P2.4 on the left half of the road 17B as the construction machine 1 advances. The data acquisition takes place in each case after a predetermined distance a has been covered or after a predetermined time interval Δt has elapsed. Consequently, the roadway can be divided into a sequence of regions or fields F1.1, F1.2, F1.3, F1.4, and F2.1, F2.2, F2.3, F2.4 in which the data acquisition takes place. In the present exemplary embodiment, these regions are each of the same size, because the distance a or the time interval Δt is not changed during the uniform advancement of the machine. However, the regions can also be of different sizes, or the data acquisition can take place continuously.

In the present exemplary embodiment, an evaluation variable B, e.g., the mean signal strength of the received GNSS signals, is determined from the signal strength of the GNSS signals, which also comprise correction signals, for each region F1.1, F1.2, F1.3, F1.4, and F2.1, F2.2, F2.3, F2.4. The individual evaluation variables are stored in a memory in the form of a table.

However, the signal strength is to be understood only as an example of an evaluation variable B. The evaluation variable can be any variable which is decisive for the accuracy of the positioning in a DGNSS. This variable can also be a variable characteristic of the quality of correction signals. The present exemplary embodiment describes only the determination of one valuation variable in each case. However, several evaluation variables can also be determined. Individual evaluation variables can also be determined from several valuation parameters.

The GNSS evaluation variable acquisition device 14 is set up in such a way that, with the position data that are determined by the GNSS receiver 9 at the particular locations (waypoints) on the terrain, a spatial GNSS telemetry data set describing the quality of the GNSS signals at the corresponding locations (path points) is generated.

The GNSS evaluation variable acquisition device 14 is set up such that the position data determined by the GNSS receiver 9 are assigned to the individual waypoints P1.1, P1.2, P1.3, P1.4 and P2.1, P2.2, P2.3, P2.4.

FIG. 4 shows the table in which the evaluation variables B(P1.1), B(P1.2), B(P1.3), B(P1.4) or B(P2.1), B(P2.2), B(P2.3), B(P1.4) determined at the waypoints P1.1, P1.2, P1.3, P1.4 on the right half of the road 17A and at the waypoints P2.1, P2.2, P2.3, P2.4 on the left half of the road 17B are stored, wherein coordinates x, y, z (position data) are associated with the waypoints P1.1, P1.2, P1.3, P1.4 and P2.1, P2.2, P2.3, P2.4 in a coordinate system independent of the construction machine 1. In the present exemplary embodiment, these data form the GNSS telemetry data set which is stored in a memory.

Furthermore, the GNSS evaluation variable acquisition device 14 can be set up in such a way that, in order to generate the spatial GNSS telemetry data set, the at least one GNSS evaluation variable evaluating the quality of the GNSS signal at the particular location is evaluated taking into account at least one evaluation criterion. In the present exemplary embodiment, the average signal strength of the GNSS signals received at the particular waypoints is compared with a predefined limit value in order to make the decision whether the GNSS evaluation variable at the individual waypoints satisfies or does not satisfy the evaluation criterion, i.e., whether the mean signal strength is greater than the limit value or not. If the average signal strength is greater than the limit value, it is assumed that no further precautions need to be taken for the subsequent laying of the asphalt with the road paver. However, if the average signal strength is less than the limit value, suitable precautions must be taken. In the present exemplary embodiment, the GNSS telemetry data set comprises data which indicate whether the average signal strength is greater than the limit value or not, which is illustrated in the table by the symbols O (greater than the limit value) or X (less than the limit value or the same limit value).

The GNSS evaluation variable acquisition device 14 interacts with the mobile radio communications device 12 in such a way that the spatial GNSS telemetry data set is sent to a cloud memory 18 of an Internet service provider. Consequently, the GNSS telemetry data set is available at any time for further processing.

The construction machine 1, the cloud memory 18, and a data processing device 19, which has a mobile radio communications device 19A for establishing a mobile radio connection, form a system for working the ground that allows the evaluation of the GNSS signals. The mobile radio telemetry data set can be read out from the cloud memory 18 with the data processing device 19 and processed for further evaluation and visualization.

In the present exemplary embodiment, the GNSS evaluation variable acquisition device 14 is furthermore set up in such a way that the values of the at least one GNSS evaluation variable B(P1.1), B(P1.2), B(P1.3), B(P1.4) or B(P2.1), B(P2.2), B(P2.3), B(P2.4) evaluating the quality of the GNSS signals at the respective location are assigned regions F1.1, F1.2, F1.3, F1.4 and F2.1, F2.2, F2.3, F2.4, in order to display the values of the at least one GNSS evaluation variable at the respective locations in a graphical representation of the area (road) to be worked by the construction machine 1 as color-coded regions or fields, or regions or fields coded by different shading. The GNSS evaluation variable acquisition device 14 can generate an image file which contains the corresponding image data, wherein the image file is uploaded to the cloud memory 18. This image file can then be downloaded from the cloud memory 18 by the data processing device 19, opened, and displayed on a screen 19B of the data processing device 19.

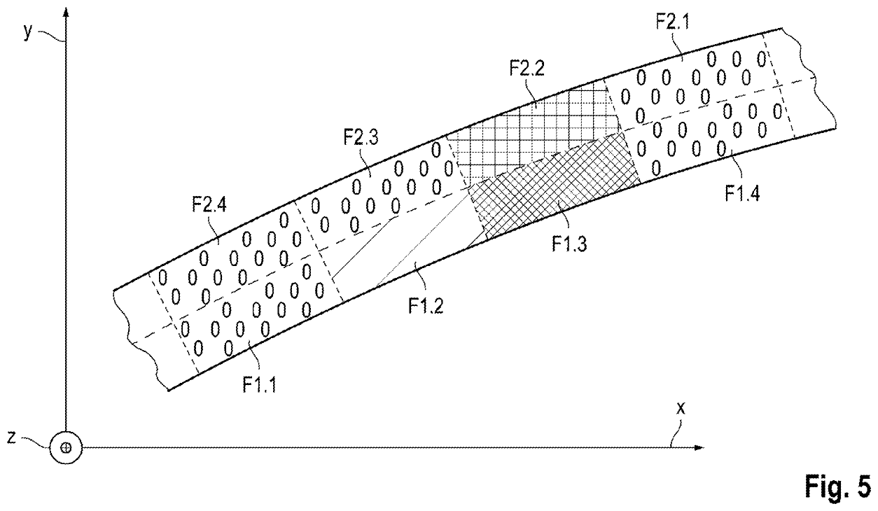

FIG. 5 shows a graphical representation of the road to be processed in an (x, y, z) coordinate system, wherein, in the road 17, the regions or fields F1.1, F1.2, F1.3, F1.4 and F2.1, F2.2, F2.3, F2.4, which are described with reference to FIGS. 3A and 3B, are marked in which the quality of the GNSS signals is shown. In the present exemplary embodiment, the regions F1.1, F1.2, F1.3, F1.4, and F2.1, F2.2, F2.3, F2.4, in which the signal quality is sufficient, are marked with the symbols O, while the regions F1.1, F1.2, F1.3, F1.4, and F2.1, F2.2, F2.3, F2.4, in which the signal quality is not sufficient, are hatched. The intensity of the shading is characterized by the density of the hatching, wherein a density of hatching means a strong shading.

The construction machine 1 allows the evaluation not only of the quality of the GNSS signals, but also that of the mobile radio signal received by the mobile radio communications device 19. The mobile radio evaluation device 15 and the mobile radio evaluation variable acquisition device 16 differ from the GNSS evaluation device 13 and the GNSS evaluation variable acquisition device 14 in that the mobile radio signal is evaluated instead of the GNSS signals of several satellites 10. Consequently, other evaluation variables or evaluation criteria are defined. In the present exemplary embodiment, the mobile radio evaluation device 15 is set up such that a value correlating with the signal strength of the mobile radio signal, and/or a value correlating with the runtime of the mobile radio signal, and/or a value correlating with the upload rate and/or download rate of the mobile radio signal is determined as a mobile radio evaluation variable evaluating the quality of the mobile radio signal. For example, the RSSI (received signal strength indicator) value of the mobile radio signal can be compared with a predefined limit value which is sufficient for a proper mobile radio connection. The visualization can take place in the same way as for the GNSS signals. The regions F1.1, F1.2, F1.3, F1.4, and F2.1, F2.2, F2.3, F2.4 of the road 17, in which the signal strength of the mobile radio signal is above or below the limit value, can be represented in a plan which corresponds to the plan shown in FIG. 5.

The mobile radio evaluation device 15 and the mobile radio evaluation variable acquisition device 16 otherwise have an analogous structure and an analogous mode of operation, so that reference is made to the description of the GNSS evaluation variable acquisition device 13 and the GNSS evaluation variable acquisition device 14.

The GNSS receiver (9) and the mobile radio communications device 12 can also interact as follows.

If correction signals are received from the mobile radio communications device 12 to increase the accuracy of the positioning, the mobile radio evaluation device 15 can also determine an evaluation variable evaluating the quality of the correction signals.

In the event that the positioning is carried out based on the processing of correction signals contained in the GNSS signals and received by the GNSS receiver, and it is to be determined that the correction signals to be processed by the GNSS receiver are of insufficient quality, the computing unit (9B) of the GNSS receiver (9) can be configured in such a way that the positioning is carried out, not based on correction signals received from the GNSS receiver, but based on correction signals received from the mobile radio communications device 12. In this case, it can also be checked whether these correction signals are of sufficient quality. In an analogous manner, the GNSS receiver (9) may also be set up in such a way that, in the event that insufficient quality of correction signals which are received by the mobile communications device 12 is detected, the positioning takes place on the basis of correction signals that are received by the GNSS receiver.

What is claimed is:

1. A self-propelled construction machine for working a ground or erecting a structure on the ground in a preceding work process, which is followed by another work process with another construction machine, wherein the construction machine comprises:
a machine frame supported by running gears;
a working device arranged on the machine frame and configured to work the ground or erect the structure on the ground;
a mobile radio antenna configured to receive mobile radio signals;
a GNSS receiver comprising an antenna arranged at a reference point of the construction machine for receiving GNSS signals of a plurality of satellites of a global navigation satellite system; and
one or more computing units functionally linked to the mobile radio antenna and the GNSS receiver and configured to
process mobile radio signals and/or GNSS signals received at least with respect to a plurality of locations in a terrain during advance of the construction machine,
determine position data describing the position of the reference point at respective locations of the plurality of locations,
determine at least one evaluation variable evaluating the quality of the mobile radio signals and/or GNSS signals received at the respective locations,
use the position data to generate a spatial telemetry data set describing the quality of the mobile radio signals and/or the GNSS signals at the respective locations, and
direct the spatial telemetry data set to be uploaded to a cloud memory.

2. The self-propelled construction machine of claim 1, wherein the spatial telemetry data set comprises a spatial GNSS telemetry data set describing the quality of the GNSS signals, wherein the one or more computing units are configured such that at least one GNSS evaluation variable evaluating the quality of the GNSS signals at the particular location is acquired in each case after traveling a predetermined distance, or after expiration of a predetermined time interval.

3. The self-propelled construction machine of claim 1, wherein the spatial telemetry data set comprises a spatial GNSS telemetry data set describing the quality of the GNSS signals, wherein the one or more computing units are configured to assign colors to values of the at least one GNSS evaluation variable evaluating the quality of the GNSS signals at the corresponding location in order to display the values of the at least one GNSS evaluation variable at the corresponding locations in a graphical representation of an area to be processed by the construction machine as color-coded regions.

4. The self-propelled construction machine of claim 1, wherein the spatial telemetry data set comprises a spatial GNSS telemetry data set describing the quality of the GNSS signals, wherein the one or more computing units are configured, in order to generate the spatial GNSS telemetry data set, to evaluate at least one GNSS evaluation variable taking into account at least one evaluation criterion, and to determine whether the at least one GNSS evaluation variable satisfies the at least one evaluation criterion at the respective location, or whether the at least one GNSS evaluation variable does not satisfy the at least one evaluation criterion.

5. The self-propelled construction machine of claim 1, wherein the spatial telemetry data set comprises a spatial GNSS telemetry data set describing the quality of the GNSS signals, wherein the one or more computing devices are configured to determine a value correlating with a signal strength of the GNSS signals of the satellites of a global navigation satellite system and/or a value correlating with the satellite geometry as a GNSS evaluation variable evaluating the quality of the GNSS signals.

6. The self-propelled construction machine of claim 1, wherein the spatial telemetry data set comprises a spatial mobile radio telemetry data set describing the quality of the mobile radio signals, wherein the one or more computing units are configured such that, to generate the spatial mobile radio telemetry data set during the advance of the construction machine, at least one mobile radio evaluation variable is acquired in each case after traveling a predetermined distance, or after the expiration of a predetermined time interval.

7. The self-propelled construction machine of claim 1, wherein the spatial telemetry data set comprises a spatial mobile radio telemetry data set describing the quality of the mobile radio signals, wherein the one or more computing units are configured such that colors are assigned to values of at least one mobile radio evaluation variable evaluating the quality of the mobile radio signal at a corresponding location in order to display the values of the at least one mobile radio evaluation variable at the corresponding locations in a graphical representation of an area to be processed by the construction machine as color-coded regions.

8. The self-propelled construction machine of claim 1, wherein the spatial telemetry data set comprises a spatial mobile radio telemetry data set describing the quality of the mobile radio signals, wherein the one or more computing units are configured such that, in order to generate the spatial mobile radio telemetry set, at least one mobile radio value evaluating the quality of the mobile radio signal at the respective location is evaluated taking into account at least one evaluation criterion, and to determine whether the at least one mobile radio evaluation variable satisfies the at least one evaluation criterion at the respective location, or whether the at least one evaluation variable does not satisfy the at least one evaluation criterion.

9. The self-propelled construction machine of claim 1, wherein the spatial telemetry data set comprises a spatial mobile radio telemetry data set describing the quality of the mobile radio signals, wherein the one or more computing units are configured such that a value correlating with a signal strength of the mobile radio signal, and/or a value correlating with a runtime of the mobile radio signal, and/or a value correlating with an upload rate and/or download rate of the mobile radio signal is determined as a mobile radio evaluation variable evaluating the quality of the mobile radio signal.

10. A method for working a ground or erecting a structure on the ground with a self-propelled construction machine in a preceding work process, which is followed by another work process with another construction machine, wherein the construction machine comprises a mobile radio communications device for establishing a mobile radio connection and a GNSS receiver for determining position data describing a position of a reference point of the construction machine, the method comprising:
during an advance of the construction machine determining at least one evaluation variable evaluating the quality of mobile radio signals received by the mobile radio communications device and/or GNSS signals received by the GNSS receiver at respective locations in the terrain;
with the position data of the GNSS receiver, generating a spatial GNSS telemetry data set describing the quality of the mobile radio signals and/or GNSS signals at the respective locations in the terrain; and
transmitting the spatial GNSS telemetry data set to a cloud memory via the mobile radio communications device.

11. The method of claim 10, wherein a value correlating with a signal strength of the GNSS signals of satellites of a global navigation satellite system and/or a value correlating with a satellite geometry is determined as an evaluation variable evaluating the quality of the GNSS signals.

12. The method of claim 10, wherein a value correlating with a signal strength of the mobile radio signal, and/or a value correlating with a runtime of the mobile radio signal, and/or a value correlating with an upload rate and/or download rate of the mobile radio signal is determined as an evaluation variable evaluating the quality of the mobile radio signal.

13. The method of claim, wherein a data processing device is provided with the mobile radio communications device for establishing a mobile radio connection, the telemetry data set is read out from the cloud memory using the data processing device, and the data of the telemetry data set are processed with the data processing device.

14. The method of claim 13, wherein the data of the telemetry data set processed with the data processing device are visualized on a screen of the data processing device.

15. A system comprising:
a self-propelled construction machine for working a ground or erecting a structure on the ground in a preceding work process, which is followed by another work process with another construction machine, the construction machine comprising a machine frame supported by running gears, a working device arranged on the machine frame, a mobile radio antenna configured to receive mobile radio signals, and a GNSS receiver comprising an antenna arranged at a reference point of the construction machine for receiving GNSS signals of a plurality of satellites of a global navigation satellite system;
a cloud memory; and
one or more computing units functionally linked to the mobile radio antenna and the GNSS receiver and configured to
process mobile radio signals and/or GNSS signals received at least with respect to a plurality of locations in a terrain during advance of the construction machine,
determine position data describing the position of the reference point at respective locations of the plurality of locations,
determine at least one evaluation variable evaluating a quality of the mobile radio signals and/or GNSS signals received at the respective locations,
use the position data to generate a spatial telemetry data set describing the quality of the mobile radio signals and/or GNSS signals at the particular locations, and
direct the spatial telemetry data set to be uploaded to the cloud memory.

16. The system of claim 15, further comprising a data processing device having a mobile radio communications device for establishing a mobile radio connection and configured such that the telemetry data set is read out of the cloud memory, and the data of the telemetry data set are processed to be visualized on a screen of the data processing device.

17. The system of claim 15, wherein the one or more computing units are configured to determine a value correlating with a signal strength of the GNSS signals of satellites of a global navigation satellite system and/or a value correlating with a satellite geometry as an evaluation variable evaluating the quality of the GNSS signals.

18. The system of claim 15, wherein the one or more computing units are configured to determine a value correlating with a signal strength of the mobile radio signal, and/or a value correlating with a runtime of the mobile radio signal, and/or a value correlating with an upload rate and/or download rate of the mobile radio signal as an evaluation variable evaluating the quality of the mobile radio signal.
